(19) United States
(12) Patent Application Publication
(10) Pub. No.: US 2014/0332641 A1
(43) Pub. Date: Nov. 13, 2014

(54) SUPPORT FOR CIRCULAR OBJECTS

(71) Applicant: ERICO International Corporation, Solon, OH (US)

(72) Inventors: Jeffrey A. Wilson, Cuyahoga Falls, OH (US); Eric C. Osborn, Medina, OH (US); Scott E. Anderson, Garrettsville, OH (US)

(73) Assignee: ERICO International Corporation, Solon, OH (US)

(21) Appl. No.: 14/270,689

(22) Filed: May 6, 2014

Related U.S. Application Data
(60) Provisional application No. 61/819,779, filed on May 6, 2013.

(51) Int. Cl. F16L 3/08

(52) U.S. Cl. CPC F16L 3/08
USPC 248/71

(57) ABSTRACT

An object support includes a clamp, and a base for receiving the clamp, with the clamp securing an object, such as a pipe, to the base. The base may have a trapezoidal shape, with a rectangular bottom surface that is larger than a rectangular top surface. The top surface may have a series of holes for receiving legs of the clamp that are on opposite ends of a linking portion or body of the clamp. The legs are inserted into the base on opposite sides of the object to be clamped, with the clamps legs engaging the holes, and with the linking portion pinning the object to be clamped against the top surface of the base. The legs may have textured surfaces, for example having ridges or threads, that engage the holes to secure the legs to the base.

This application claims priority from U.S. Provisional Application 61/819,779, filed May 6, 2013, which is incorporated by reference in its entirety.

### BACKGROUND OF THE INVENTION

1. Field of the Invention

The invention is in the field of object supports, such as rooftop supports for pipes or other objects.

2. Description of the Related Art

There is a general need to provide support for rooftop piping systems such as electrical conduits, natural gas piping and condensate drain lines. The supports must elevate the piping or equipment high enough to clear common rooftop obstacles (like expansion joints and seams). The elevation also serves to keep the piping from lying directly in standing water or to provide the necessary slope for drain or condensate lines. In addition, the supports often need to be free-floating to avoid penetrating the roof membrane, as well as to accommodate movement in the piping system due to expansion or contraction in the piping due to extreme temperature fluctuations. Currently, the most common method of providing support uses short lengths of pressure-treated lumber (typically a nominal 10 cm×10 cm (4 inches×4 inches)) as a support, with the pipe held in place using commonly available one-hole or two-hole pipe straps.

There are a number of issues with this method of support: the wood will eventually rot to the extent that it is no longer providing the necessary support, the hardware will rust, splinters or sharp edges on the wood can penetrate the roof membrane, etc. In addition, the wood is heavy and difficult to move, and additional tools (saw and screwdriver or socket wrenches) are required for installation. More recently, quasi-engineered rooftop pipe supports have been introduced into the market. These products, while overcoming many of the issues associated with the lumber method, may have their own shortcomings, as most require the use of strut hardware to secure the pipe, and most do not offer the ability to accommodate elevation changes. Further, some of these products are very light, leaving them prone to movement by wind and errant workers.

FIGS. 1 and 2 show an example of a prior pipe support 1 that includes a base 2 with a strut 3 attached to its top surface. Strut fittings, such as the clamps 4 and 5, are used to secure pipe runs 6 and 7 to the support 1. The installer must supply different clamps for different sizes of pipe and use tools to assemble the clamps to the pipe/strut.

Other supports include those shown in U.S. Pat. No. 8,356,778 and U.S. Patent Publications 2006/0131465 and 2007/0120036.

### SUMMARY OF THE INVENTION

According to aspects of the invention, a support for an object includes: a base; and a clamp that engages the base to secure the object to the base; wherein the support includes one or more of the following features: the clamp includes a pair of legs that are inserted into the base; the clamp also includes a portion linking the legs; the linking portion engages the object when the object is secured to the base by the clamp; the linking portion has a V shape; the linking portion has a U shape; the linking portion has substantially the same cross-sectional area and/or cross-sectional shape (for example, circular) as the legs; the legs have protrusions that engage the base; the protrusions are threads; the protrusions are non-threaded, such as ribs, grooves, dimples, wedges, and/or arrow heads; the clamp is made of steel; the clamp is made of plastic; the base includes a locking feature for securing the clamp to the base; the locking feature is releasable, allowing the clamp to be disengaged from the base; the locking feature is reusable, allowing securing of clamps multiple times and/or in multiple locations; the locking feature includes clamping holes in the base; the clamp is installed onto the base with less force than is needed to remove the clamp from the base; the base includes holes that receive the legs of the clamp; the holes in the base include storage holes for storing the clamp, prior to use; the storage holes are on a side of the base; the holes in the base include clamping holes for receiving the legs, to secure the object to the base; the clamping holes are in a top surface of the base; the clamping holes engage protrusions in the legs, to secure the clamp to the base; the clamp includes fingers that extend into the clamping holes and engage the leg protrusions; the fingers act as barbs, in securing the legs within the clamping holes; the fingers are deformed by insertion of the legs; the fingers are bent toward a bottom of the base, the bending being in the same direction that the legs are inserted into the clamping holes; the fingers are part of a plate that is along the top surface of the base; the plate is a metal plate, such as a steel plate; the plate is secured to a lower portion of the base; the lower portion is made of a non-metallic material, such as a polymer, for example polypropylene or another plastic; the base includes a non-metallic material, such as a polymer, for example polypropylene or another plastic; substantially all of the base is made of the non-metallic material; the base is a single piece of unitary continuous material; the clamping holes are holes in deformable plastic of the base; insertion of the legs into the holes deforms the deformable plastic, engaging protrusions on the legs, thereby securing the clamp to the base; the clamping holes are in an array of clamping holes on the top surface of the base; the array of clamping holes includes holes for receiving multiple objects and/or for receiving objects of various different sizes; the base has a bottom surface that has a larger area than a top surface of the base; the base has a rectangular bottom surface and a rectangular top surface; the length of the bottom surface is greater than the length of the top surface; the width of the bottom surface is greater than the width of the top surface; the bottom surface and the top surface are substantially parallel; the base has sloped side surface extending from the bottom surface to the top surface; the base has a trapezoidal cross section in at least one direction; the base has a trapezoidal cross section in multiple directions, for vertical planes perpendicular to the bottom surface; the base has a trapezoidal cross section for substantially all vertical planes perpendicular to the bottom surface; the base has one or more saw tooth or wave-shape protrusions at one or more ends of the top surface; the saw tooth or wave-shape protrusions aid in placement of circular objects, such as pipes, along the top surface; and/or the support is a rooftop pipe support.

According to an aspect of the invention, a support for an object includes: a base; and a clamp that engages the base to secure the object to the base. The clamp includes a pair of legs that are inserted into holes in a top surface of the base.

According to another aspect of the invention, a method of supporting an object includes the steps of: placing the object on a base; and after the placing, securing a clamp to the base by inserting legs in the clamp into holes in a top surface of the base, thereby clamping the object between the base and the clamp.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is an oblique view of a prior art pipe support.

FIG. 2 is an oblique view of a pipe mounting using the prior art pipe support of FIG. 1.

FIG. 3 is an oblique view of a clamp that is part of an object support, according to an embodiment of the present invention.

FIG. 4 is an oblique view of the object support that includes the clamp of FIG. 3.

FIG. 5 is an oblique view showing a first step in installing an object on the support of FIG. 4.

FIG. 6 is an oblique view showing a second step in the installation process.

FIG. 7 is an oblique view showing an alternate installation using the support of FIG. 4, for installing an object of a different size.

FIG. 8 is a magnified partial cutaway view showing a first embodiment of holes in the base for receiving the clamp.

FIG. 9 is a magnified partial cutaway view showing a second embodiment of holes in the base for receiving the clamp.

FIG. 10 is a magnified partial cutaway view showing a third embodiment of holes in the base for receiving the clamp.

FIG. 11 is an oblique view of an object support, according to another embodiment of the invention.

FIG. 12 is an oblique view of a clamp of the object support of FIG. 11.

FIG. 13 is an oblique view of part of the clamp of FIG. 12.

FIG. 14 is a magnified partial cutaway view of a leg of the clamp of FIG. 12 entering a hole in a base of the support of FIG. 11.

FIG. 15 is an oblique view of the object support of FIG. 11, being used to support a first object.

FIG. 16 is an oblique view of the object support of FIG. 11, being used to support a second object.

FIG. 17 is an oblique view of the base of the object support of FIG. 11, with a strut mounted on it.

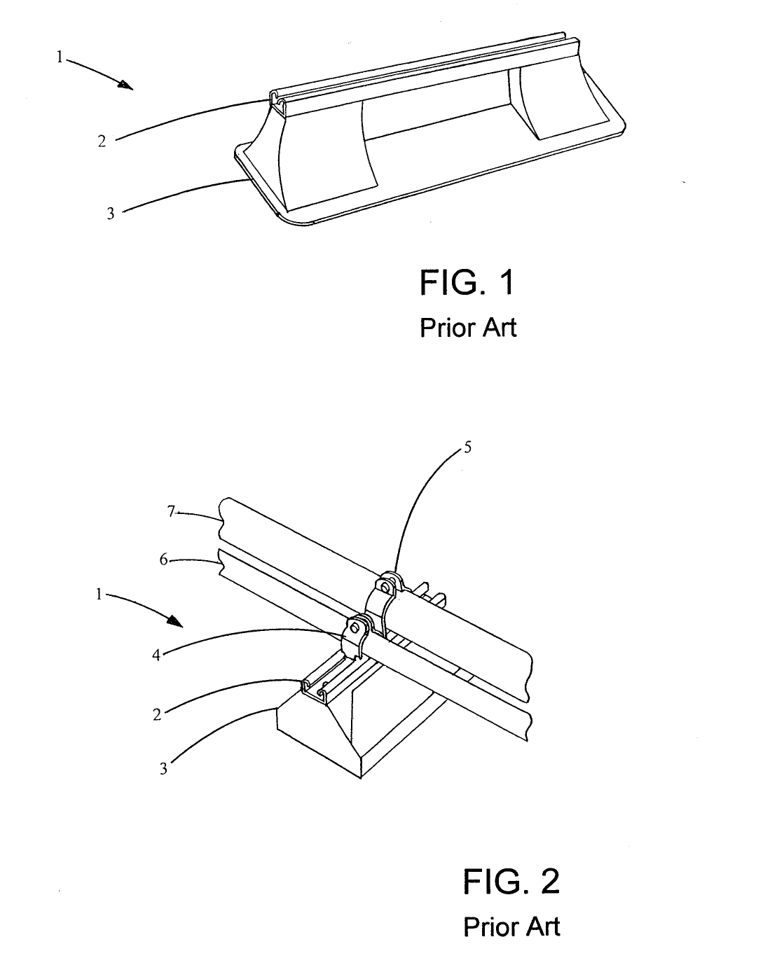

### DETAILED DESCRIPTION

An object support includes a clamp, and a base for receiving the clamp, with the clamp securing an object, such as a pipe, to the base. The base may have a trapezoidal shape, with a rectangular bottom surface that is larger than a rectangular top surface. The top surface may have a series of holes for receiving legs of the clamp that are on opposite ends of a linking portion or body of the clamp. The legs are inserted into the base on opposite sides of the object to be clamped, with the clamps legs engaging the holes, and with the linking portion pinning the object to be clamped against the top surface of the base. The legs may have textured surfaces, for example having ridges or threads, that engage the holes to secure the legs to the base.

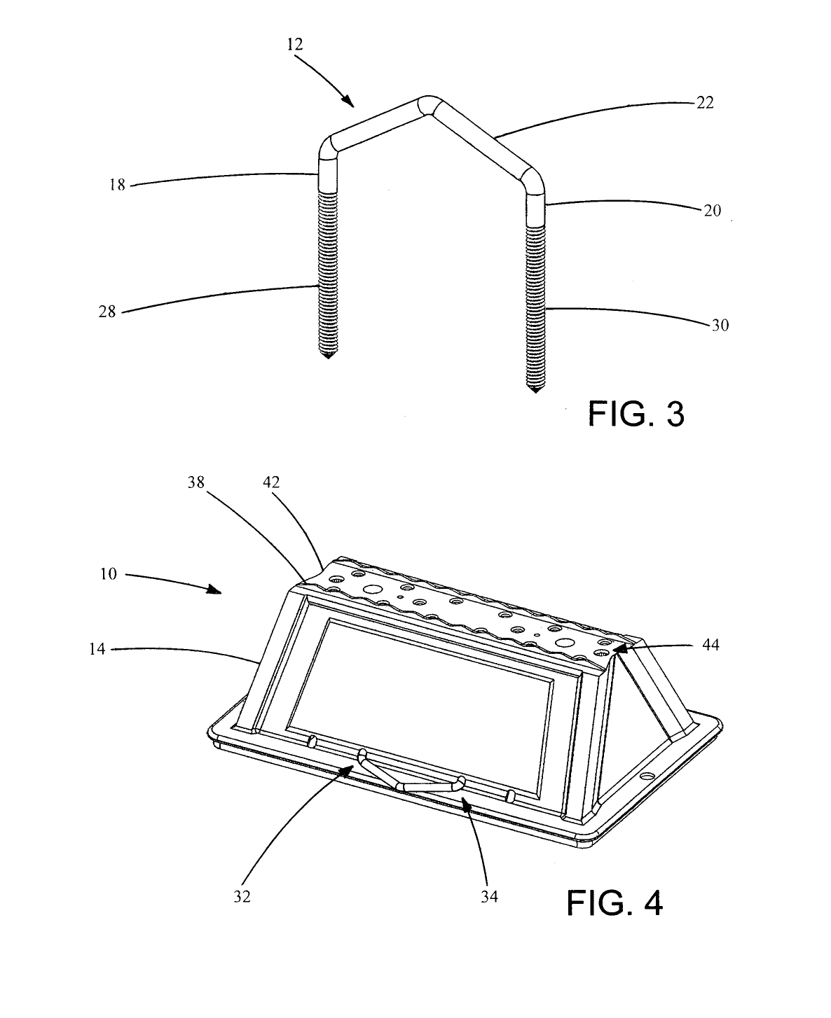

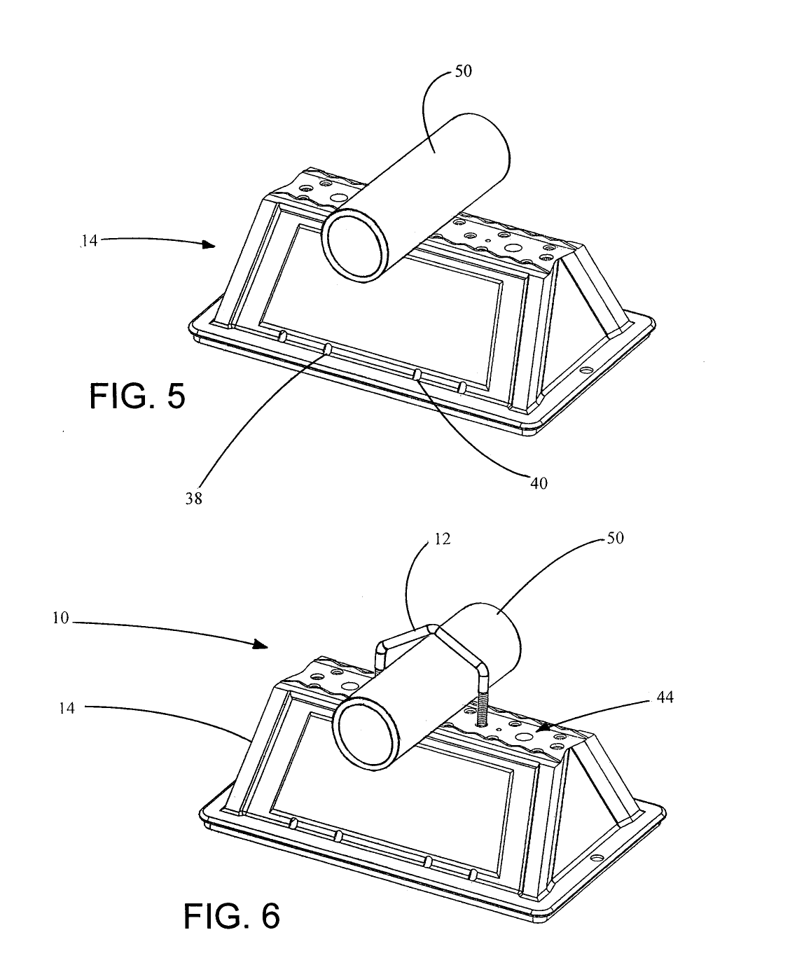

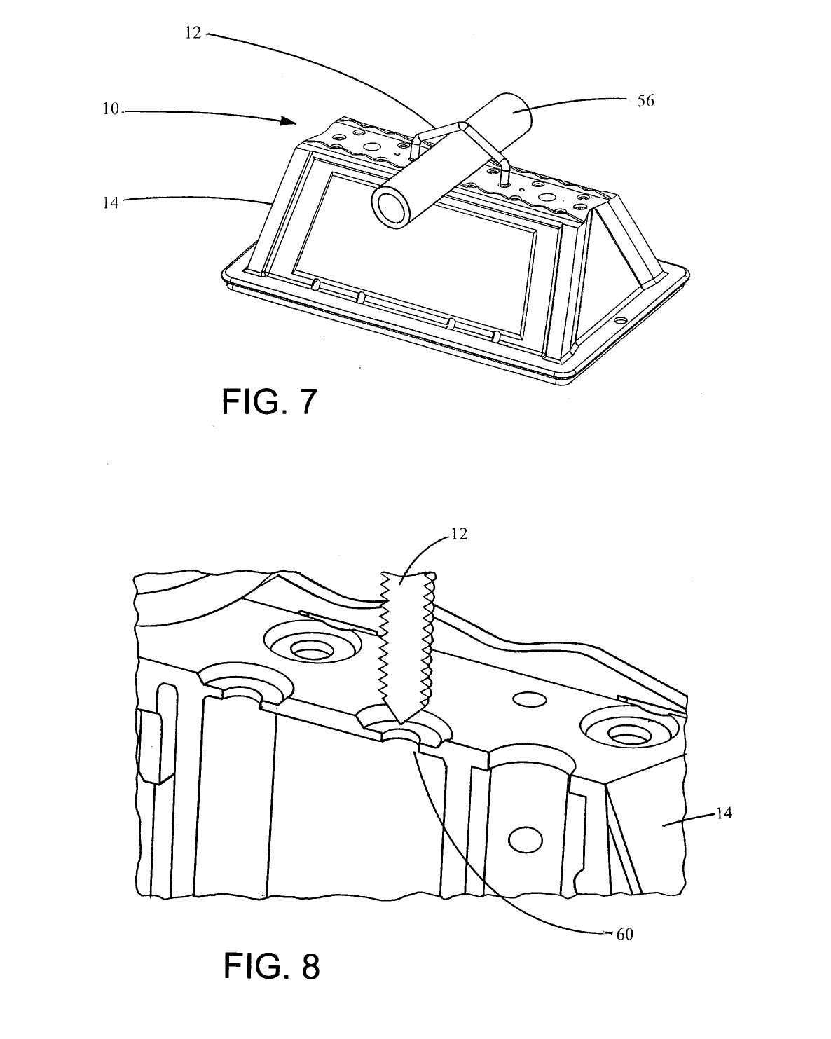

FIGS. 3-10 show various aspects of multiple embodiments of an object support 10. The object support 10 includes a clamp 12 (FIG. 3) that may be used to quickly secure pipe (or other object) to a base 14 (FIG. 4), for example as part of a rooftop support. The clamp 12 may be made of steel. The clamp 12 has legs 18 and 20, linked by a linking portion 22. The legs 18 and 20 may have threads on portions or ends 28 and 30 that engage a locking mechanism in the top of the support base 14. The clamp 12 alternatively 1) can be made from materials other than steel, 2) can use a profile other than threads (ribs or other protrusions, for example) to lock into the support base 14, and/or 3) may have a shape other than a V shape (for example having a U shape).

The support base 14 may initially house the clamp 12 in horizontal storage holes 32 and 34 in a side surface of the base 14, until the pipe (or other object) is ready to be installed. The base 14 has a trapezoidal shape, with a rectangular bottom surface that is larger than a rectangular top surface 42 (in length and/or width). Such a shape provides stability when the base 14 is installed on a rooftop to support a pipe or conduit run, for example. The top surface and bottom surface may be parallel to each other. Side surfaces extending from the bottom surface to the top surface may be sloped. Alternatively, other shapes may be used for the base 14. The top surface of the base 14 has an array of clamping holes 44, for receiving the claim 12.

The base 14 may be made of any of a variety of suitable materials, for example being made at least in part of one or more suitable polymer materials or other non-metallic materials, for example being made of polypropylene or other suitable plastics. The base 14 may be made of a hard plastic material that resists deformation. The base 14 may be a single piece of material, as shown in FIG. 4. Alternatively the base 14 may include a top plate, such as a metallic top plate, as described below. The base 14 may have suitable protrusions 38 and 40 at opposite sides of the top surface 42, to aid in positioning the pipe or other object to be clamped, and to aid in retaining the object prior to installation of the clamp 12. The protrusions 38 and 40 may have a saw-tooth shape, wavy shape, or other uneven shape, for example.

FIGS. 5 and 6 show installation steps. A pipe 50 will be installed by first placing the pipe across the support base 14 (FIG. 5). Then the clamp 12 is pulled out from the storage holes 32 and 34. Finally, as shown in FIG. 6, the clamp 12 is pushed down into the clamping holes 44 to engage the locking features on the support base 14, for example being inserted until the clamp touches the pipe 50. The amount of engagement force can be varied depending on the material of the pipe 50, for example using less force to clamp a PVC pipe.

Multiple diameters of pipes can be held with one size of clamp. FIG. 7 shows the same support 10 used to clamp a larger diameter pipe 56.

The clamps 12 will lock into the base 14 in any of a variety of ways, using various locking mechanism. FIG. 8 shows one example, with the base 14 including deformable plastic holes 60 molded into the top of the base which will interfere with the threads on the clamp 12 (FIG. 3) and resist the clamp 12 from pulling out. The material around the holes 60 deforms when the clamp 12 is installed, with the deformed material holding the clamp 12 in place.

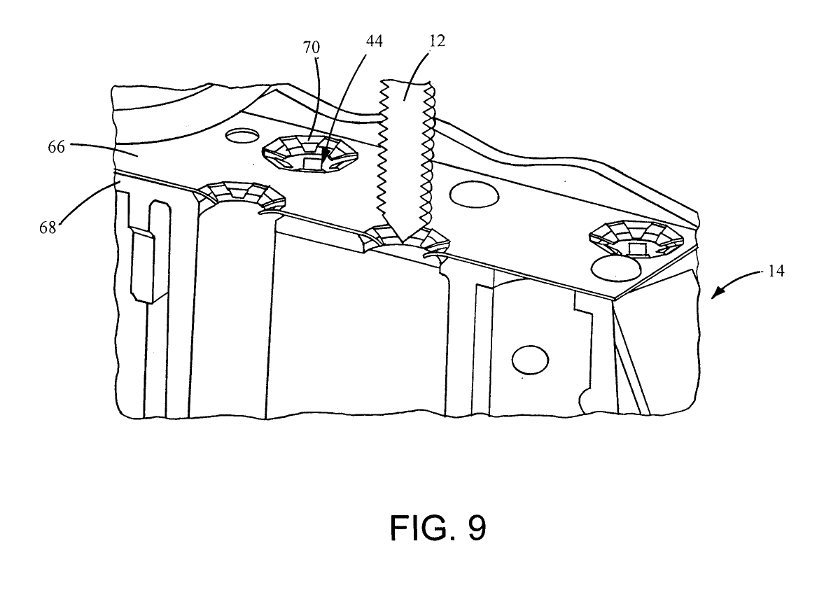

Another alternative, shown in FIG. 9, is a steel (or other metal) plate 66 secured to a lower portion 68 of the base 14. The plate 66 has fingers 70 that extend into the holes 44. The fingers 70 may be triangular pieces of the plate 66, formed by stamping of the like. The fingers 70 will bend out of the way when the clamp legs 18 and 20 (FIG. 3) are inserted, and will resist a force trying to disengage the clamp 12 or pull the legs 18 and 20 out of the holes 44. The fingers 70 thus act as barbs in retaining the clamp 12 engaged with the base 14.

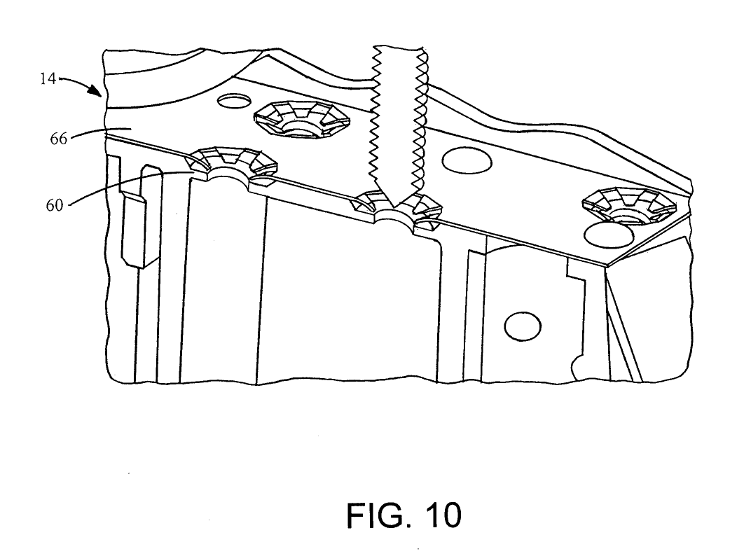

FIG. 10 shows a third alternative. In this alternative the deformable plastic holes 60 and the plate 66 are combined in a single embodiment of the base 14. Both materials/mechanisms are used to resist the clamp 12 (FIG. 3) from working loose.

The base 10 offers numerous advantages over prior devices/methods. The clamp can be installed without the need for any additional tools. The clamp-locking feature is built into the base support. The “V” shape of the clamp allows one size of clamp to work for multiple sizes of pipe. The clamps are faster to install than traditional methods. No special skills are required to fix a pipe to a rooftop support. The clamps allow for expansion/contraction of the pipe axially, while holding the pipe rigid in all other directions. The clamps and the clamp locking feature can be used multiple times. Clamps take less force to install then they take to remove. The installation of pipe can be done in all types of weather. The installer can vary the amount of force different types of pipe are clamped with (i.e., with less force applied to PVC tubing). Use of holes in the base to houses the clamp(s) during shipping. Multiple holes to accommodate a wide variety of pipe configurations/quantities of clamps. Use of an integrated metal plate with barbs securely accepts clamps.

Many alternatives are possible, only some of which have been discussed above. The clamp 12 may have a V shape, a U shape, or may be flat across its top, to give a few examples. The clamp 12 alternatively may be made of plastic or another suitable material. As an alterative to threads on the legs of the clamp 12, grooves, dimples, wedges, arrow heads, and/or ribs may be used. Threads, however, allow a large number of possible heights, potentially over a large range. The clamp 12 is discussed above as being installed by pushing down on the clamp 12 (toward the base 14). Alternatively the clamp 12 may be installed by sliding or threading down. Also, many alternatives for securing the clamp 12 to the base 14 are possible.

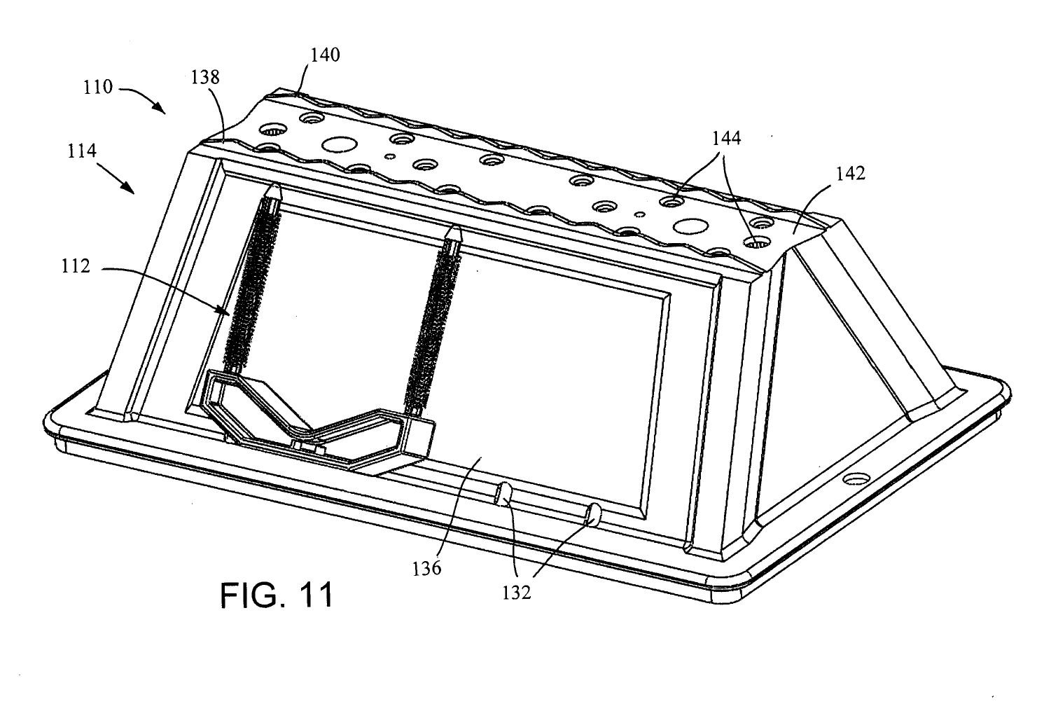

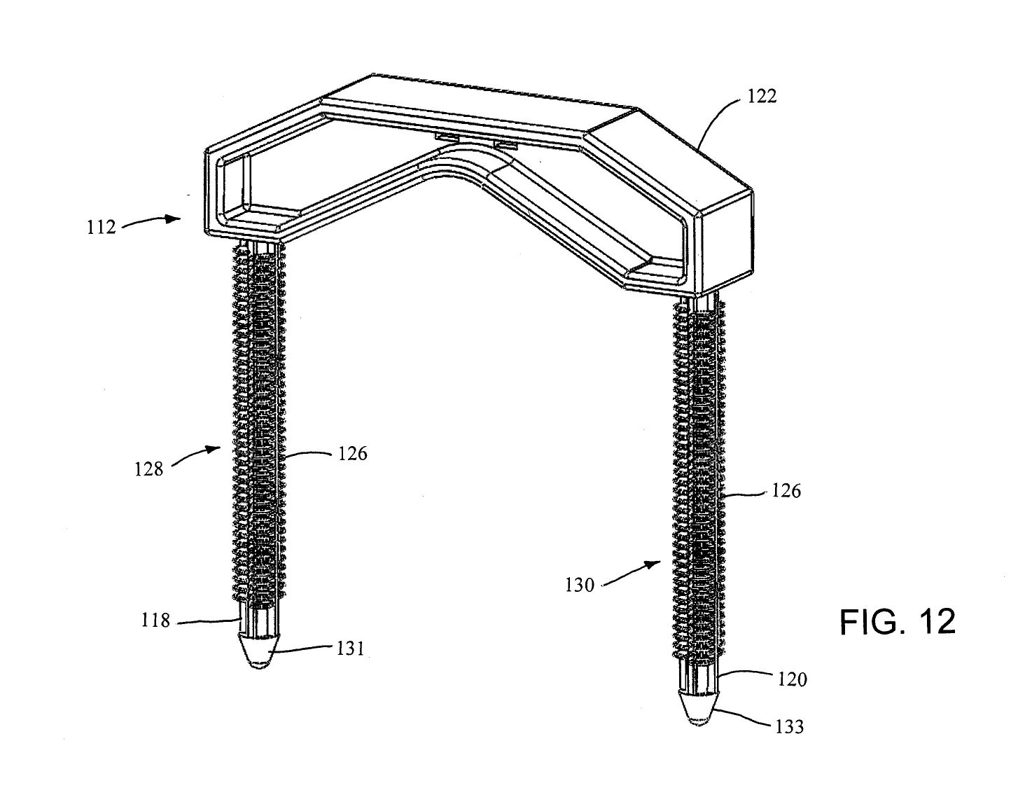

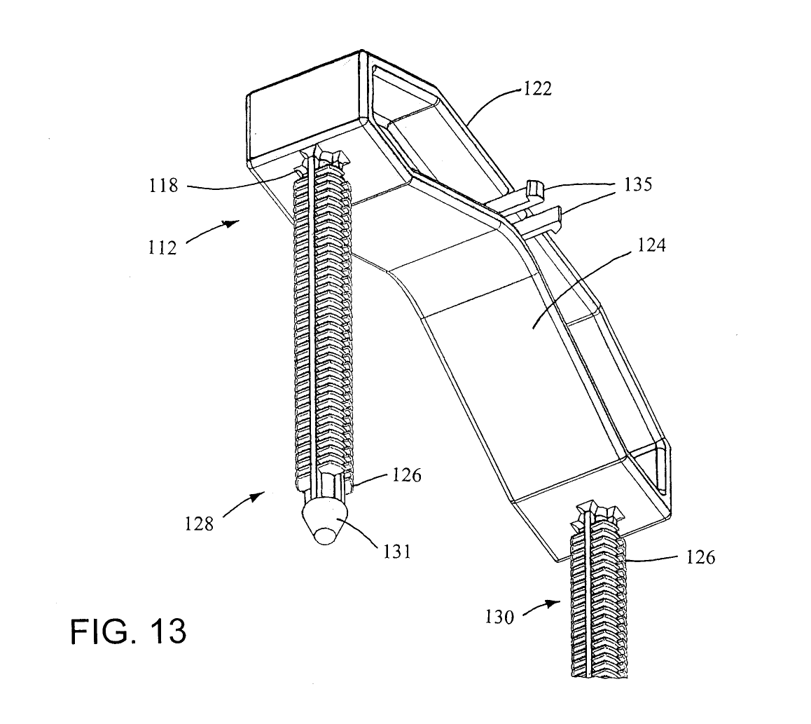

FIGS. 11-13 show an alternate embodiment, an object support 100. The object support 100 includes a clamp 112 and a base 114. Many of the aspects of the clamp 112 and the base 114 are similar to the clamp 12 (FIG. 3) and the base 14 (FIG. 4), and some of these similar aspects or features are omitted from the discussion below.

The clamp 112 is a plastic clamp, with legs 118 and 120 linked by a linking portion 122. The linking portion 122 has a V-shape inner surface 124, facing the same direction as the direction in which the legs 118 and 120 extend out of the linking portion 122. The inner surface 124 may have flat facets, which have the advantage of spreading the clamping force over an area (a longitudinal length) of the object to be clamped.

The legs 118 and 120 have protrusions or ribs 126 on portions 128 and 130 of the legs 118 and 120, respectively. The legs 118 and 120 may have cores with cruciform cross-sectional shapes, with the protrusions or ribs 126 extending between and radially beyond the arms of the cruciform cores. The legs 118 and 120 alternatively may have cores and protrusions with any of a variety of other shapes, for example with a circular cross-section core, with annular protrusions extending out from the core.

The protrusions or ribs 126 deform as the legs 118 and 120 are inserted in different holes of an array of clamping holes 144 in a top surface 142 of the base 114. The deformation of the protrusions or ribs 126 produces a force against edges of the holes 144, in order to maintain the clamp 112 engaged with the base 114. The legs 118 and 120 have conical tips 131 and 133, with rounded tips, to aid in guiding the legs 118 and 120 into the holes 144.

The linking portion 122 has a clip 135 with a pair of hooks, that engages one of the holes 132 in a side surface 136 of the base 114. This allows mechanical linkage of the clamp 112 and the base 114 prior to installation and during the early phases of installation, minimizing the number of separate parts that need to be accounted for.

The clamp 112 may be made of molded plastic. For example the clamp 112 may be made of polypropylene or other suitable plastics.

Many aspects of the base 114 are similar to those of the base 14 (FIG. 4). The base 114 may be made of materials similar to those of the base 14. The base 114 may also have suitable protrusions 138 and 140 at opposite sides of the top surface 142, to aid in positioning the pipe or other object to be clamped, and to aid in retaining the object prior to installation of the clamp 112. The protrusions 138 and 140 may have a saw-tooth shape, wavy shape, or other uneven shape, for example.

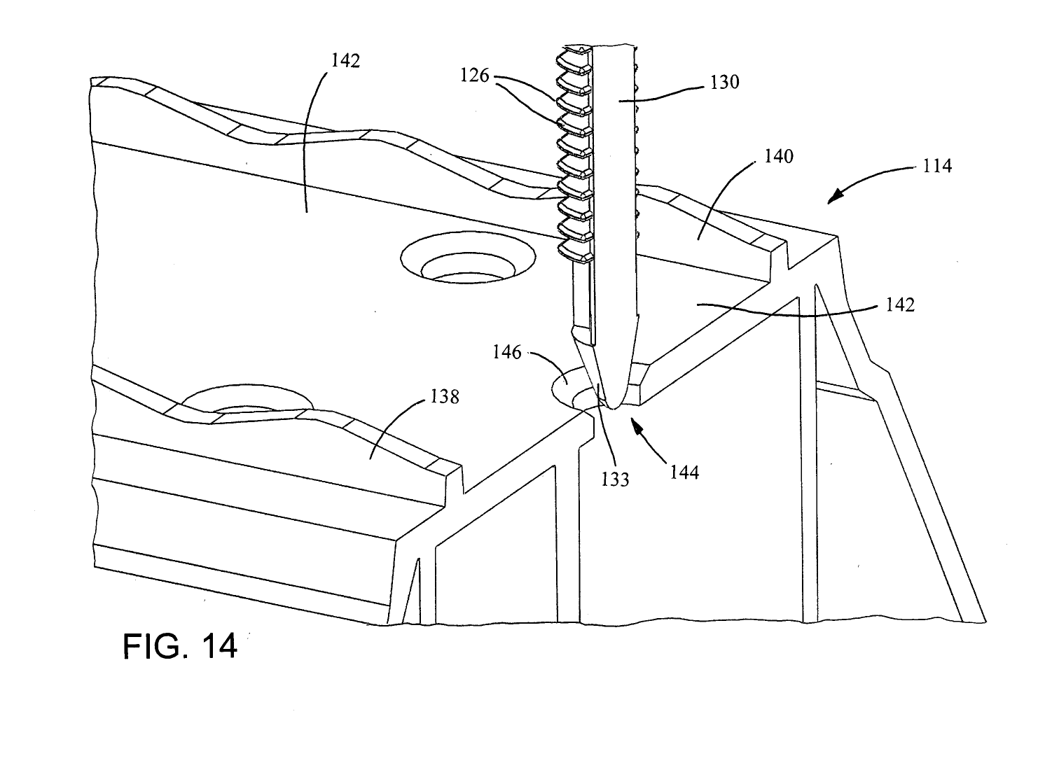

With reference to FIG. 14, insertion of the leg 130 into one of the holes 144 is shown. The hole 144 has a beveled edge 146 where it descends from the top surface 142. The beveled edge 146 aids in guiding the leg 130 into the hole 144. The holes 144 may be circular holes, and may have a diameter that is sized so as to deform the protrusions or ribs 126 when the legs 118 and 120 are inserted into the holes. The holes 144 may also be configured to allow cores of the legs 118 and 120 to pass through without deformation of either the cores or the holes.

The clamp 112 may be secured within the base 114 by deformation of the protrusions 126, as opposed to deformation of any of the material of the base 114. Still, the clamp 112 may take less force to install than it takes to remove.

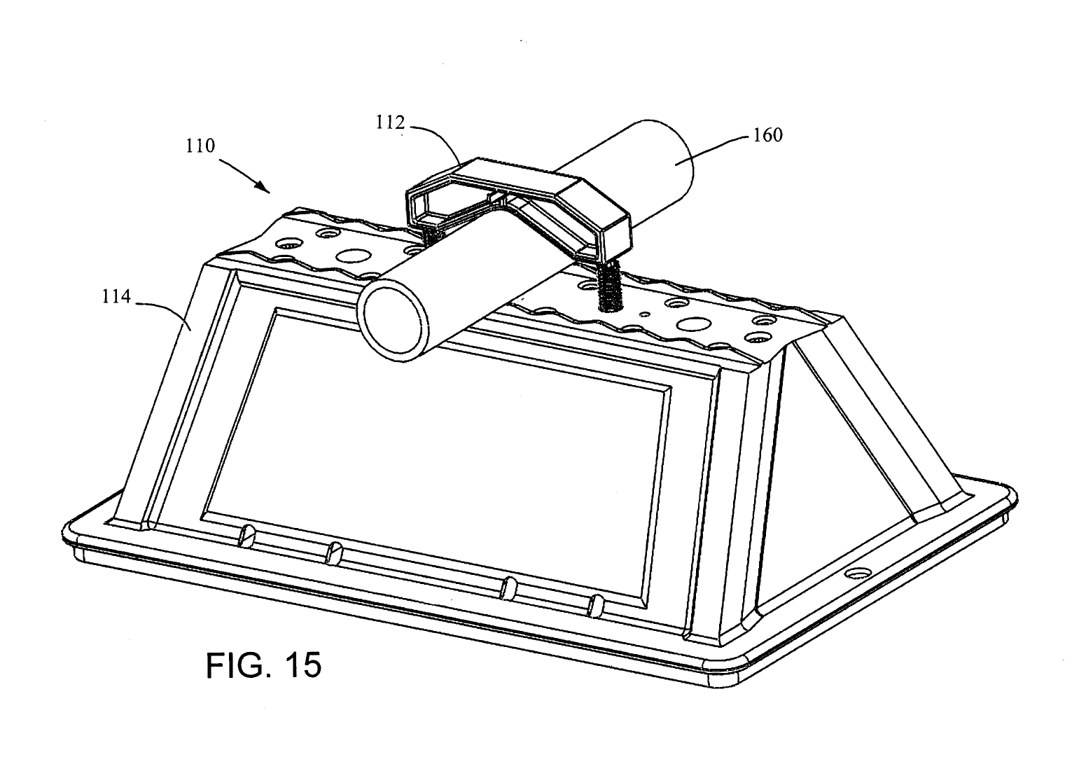

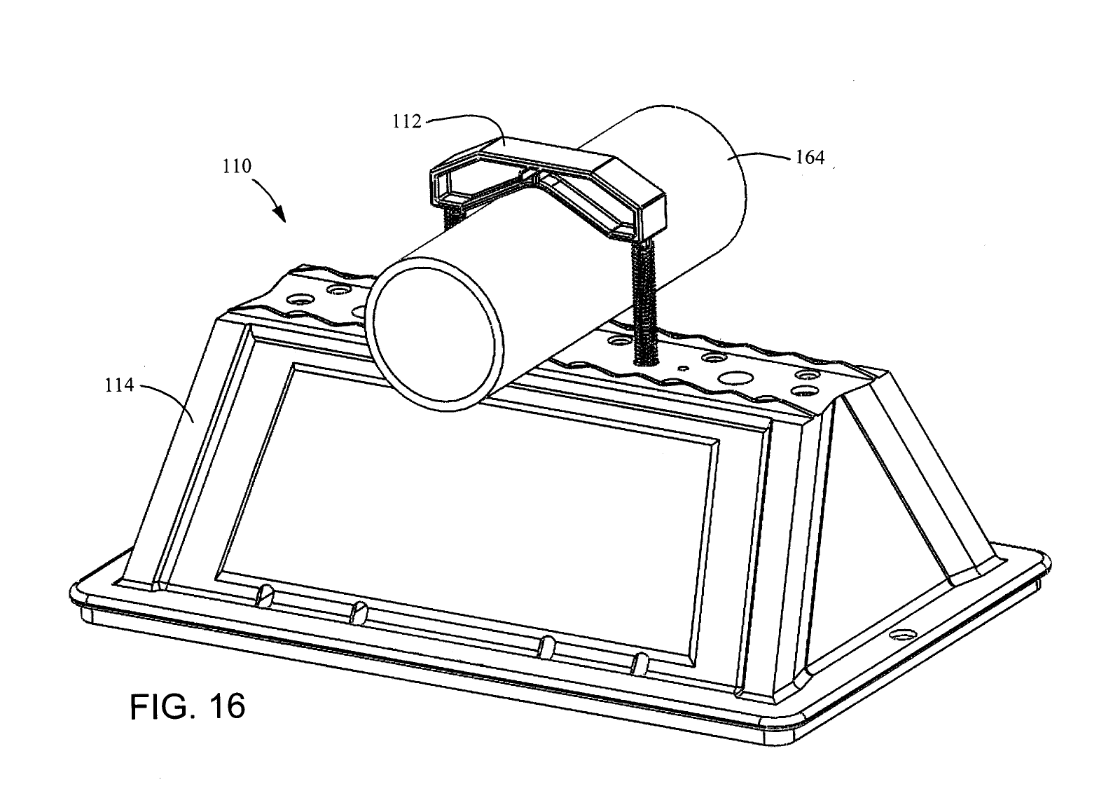

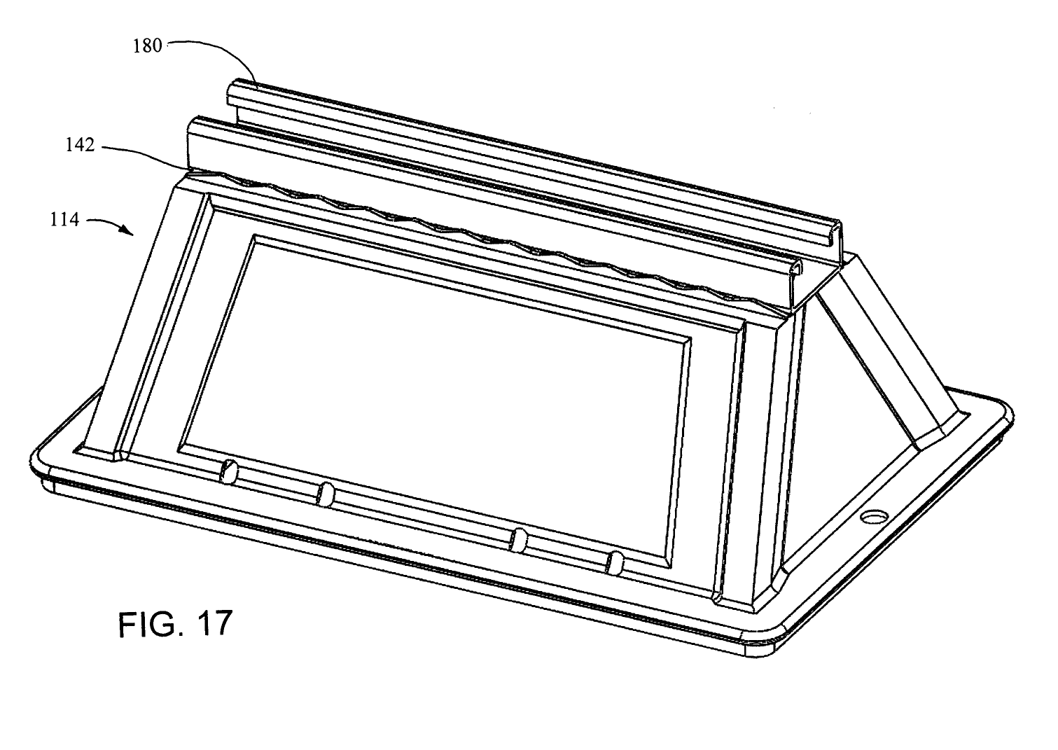

FIGS. 15 and 16 show installation of the clamp 112 on the base 114 to secure two different sizes of objects 160 and 164. The object 160 may have a diameter of 2.54 cm (1 inch) and the object 164 may have a diameter of 5.08 cm (2 inches), for example. The base 114 has an array of holes for receiving the clamp 112, similar clamps of different sizes, and/or multiple clamps, all for securing an object or objects in various configurations.

FIG. 17 shows another variation, with the base 114 having a strut 180 attached to the top surface 142. The strut 180 may be attached using any of a variety of fasteners, using some of the holes 144 (FIG. 11) in the top surface 142. The holes used to secure the strut 180 may include some of the holes used for receiving clamp legs, and/or may be holes that are configured for receiving fasteners for securing the strut. Examples of suitable fasteners for securing the strut 180 include screws, bolts, and anchors having protrusions for engaging material of the base 114. Strut fittings, such as the clamps 4 and 5 (FIG. 2) may be used to secure objects, such as pipe runs, to the strut 180. Examples of strut fittings that may be used for this purpose are RIGD heavy-duty strut clamps and SK universal strut clips, both available from ERICO International Corporation of Solon, Ohio USA.

Many variations are possible. The base may have a different shape or shapes. For example the base may be a parallelepiped shape, or may otherwise have one or more sides that are vertical when the base is placed on a roof. The base may have a top surface that has a different array of holes from that of the illustrated embodiments, for example having a different number, size, and/or placement of the holes. The top surface may be flat or may have may have undulations or other types of unevenness, for example to aid in positioning and/or retaining objects (such as round objects). The base may have any of a variety or suitable materials, and may be made in a single part or in multiple parts, for example with the multiple parts being made of different materials. For instance, all or part of the base may be made of a soft, resilient material. The interior of the base may be solid, or may have one or more hollow portions.

Many variations are also possible for the clamp. The clamp may be made of different materials than those disclosed above, and may have different configurations. Many shapes and combinations of shapes may be employed for contacting (clamping) objects of different sizes and/or shapes. The contact surfaces may include flat shapes, and/or may include shapes with curvature in any of a variety of directions relative to an object to be clamped. The linking portion may have a feature or features to facilitate gripping and manipulating the clamp, for example to install or remove the clamp. The legs of the clamp may have any of a variety of cross-sectional shapes. The ribs or protrusions for engaging the base may be configured in any of a variety of ways. The engagement of the clamp legs with the base may be due to protrusions or other surface unevenness on the legs, on the base, or on both the legs and the base. The protrusions (on the legs or the base) may extend from the core of the legs, or may be angled relative to a longitudinal axis of a leg when a leg is inserted. The clamping holes and/or the tips of the legs may have any of a variety of features to facilitate insertion of the legs into holes in the top of the base. The insertion may be angled into the base, rather than being perpendicular to the top surface of the base. The clamp may be made of a single piece of material, or may be made from multiple pieces of material. It may be possible for the clamp to have a greater or lesser number of legs, or a different configuration of legs. For instance, the clamp alternatively may be a hook with a single leg (or multiple legs) that enter into the base on only one side of the object to be clamped (although having one or more legs on each side of an object to be clamps may provide better clamping of an object such as a pipe run).

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A support for an object, the support comprising:
a base; and
a clamp that engages the base to secure the object to the base;
wherein the clamp includes a pair of legs that are inserted into holes in a top surface of the base.

2. The support of claim 1,
wherein the clamp also includes a linking portion linking the legs; and
wherein, when the legs are inserted in the holes in the top surface of the base, the linking portion engages the object when the object is secured to the base by the clamp.

3. The support of claim 1, wherein the legs have protrusions that engage the base, to secure the clamp to the base.

4. The support of claim 3, wherein the protrusions are ribs that extend out from the legs.

5. The support of claim 3, wherein the protrusions deform as the legs are inserted into the holes.

6. The support of claim 1, wherein the clamp is installed onto the base with less force than is needed to remove the clamp from the base.

7. The support of claim 1, wherein the base includes a locking feature for securing the clamp to the base, prior to insertion of the legs into the holes.

8. The support of claim 7, wherein the locking feature includes one or more holes in a side surface of the base, that are able to receive resilient hooks of the clamp.

9. The support of claim 1, wherein the holes have a circular cross section.

10. The support of claim 1, wherein the holes are in an array of three or more clamping holes on the top surface of the base.

11. The support of claim 10, wherein the array of clamping holes includes clamping holes of different sizes and/or of different spacings, for accommodating objects of different sizes.

12. The support of claim 1, wherein the base includes a non-metallic material, such as a plastic;

13. The support of claim 12, wherein the base is a single piece of unitary continuous material.

14. The support of claim 1, wherein the base has a bottom surface that has a larger area than a top surface of the base.

15. The support of claim 1, wherein the base has a trapezoidal cross section in at least one direction.

16. The support of claim 1, wherein the base has a trapezoidal cross section in multiple directions, for vertical planes perpendicular to the bottom surface.

17. The support of claim 1,
wherein the base has one or more saw tooth or wave-shape protrusions at one or more ends of the top surface; and
wherein the saw tooth or wave-shape protrusions aid in placement of circular objects, such as pipes, along the top surface.

18. The support of claim 1, wherein the support is a rooftop pipe support.

19. A method of supporting an object, the method comprising:
placing the object on a base; and
after the placing, securing a clamp to the base by inserting legs in the clamp into holes in a top surface of the base, thereby clamping the object between the base and the clamp.
